(19) United States
(12) Patent Application Publication
(10) Pub. No.: US 2014/0236704 A1
(43) Pub. Date: Aug. 21, 2014

(54) INCENTIVIZED MEDIA DELIVERY BASED ON AN EXTERNAL FACTOR

(71) Applicants: Davod Paul Billmaier, Woodinville, WA (US); Jason Christopher Hall, Seattle, WA (US); Alexander Charles Barclay, Seattle, WA (US); John Max Kellum, Seattle, WA (US); Henry Hideyuki Yamamoto, Issaquah, WA (US)

(72) Inventors: Davod Paul Billmaier, Woodinville, WA (US); Jason Christopher Hall, Seattle, WA (US); Alexander Charles Barclay, Seattle, WA (US); John Max Kellum, Seattle, WA (US); Henry Hideyuki Yamamoto, Issaquah, WA (US)

(21) Appl. No.: 14/351,875

(22) PCT Filed: Oct. 27, 2011
(86) PCT No.: PCT/US2011/058098

§ 371 Date: Apr. 14, 2014

(51) Int. Cl. G06Q 30/02

(52) U.S. Cl. CPC G06Q 30/0239
USPC 705/14.39

(57) ABSTRACT

Various example embodiments relate to incentivized media delivery. In example embodiments, a media delivery device has access to a plurality of media. The device may receive an external factor from each of a plurality of remote devices. In response, the device may select media from the media storage based on the received external factors, notify each remote device of the availability of the media, and provide an incentive for acquisition of the selected media.

### BACKGROUND

Electronic delivery of media is rapidly supplanting more conventional means of media delivery, such as the distribution of books, audio discs, video discs, and other physical materials. To this end, network-enabled electronic devices now provide access to vast quantities of digital media that can be instantaneously streamed or downloaded directly to an electronic device. At the same time, social networking, in which users share interests and activities with other users via the internet, has quickly ascended to be one of the primary uses of the internet. Social networking allows unprecedented access to other users within the network, and increasingly, access to the media consumed by those users.

### BRIEF DESCRIPTION OF THE DRAWINGS

The following detail description references the drawings, in which:

FIG. 1 is a schematic diagram depicting an example incentivized media delivery device;

FIG. 2 is a schematic diagram depicting another example incentivized media delivery device;

FIG. 3 is a flow diagram depleting an example incentivized media delivery method; and

FIG. 4 is a flow diagram depicting another example incentivized media delivery method.

### DETAILED DESCRIPTION

Social networking increasingly relies upon remote devices, such as cellular phones or other network-enabled portable devices, held by each of the users of the users of a social network. Social networking users frequently share one or more common characteristics or interests, which serve as the “link” bonding the users together. Delivery of relevant media, such as videos, images, music, and other data that is of interest to social media users would provide numerous advantages. For example, utilizing a user's location, interests, proximity to other users, and similar attributes would allow for delivery of media of potentially broad appeal to all users in a given location or social circle. Furthermore, providing an incentive to purchase the medias such as a discount would increase sales of the media within the selected group of users.

Example embodiments disclosed herein relate to an incentivized media delivery device, method, and computer-readable medium that capture these advantages. In example embodiments, a device includes a processor and access to media storage including a plurality of media items, such as music, videos, images, or electronic books. The processor may receive an external factor from each of a plurality of remote devices, where each external factor describes, for example, a geographical location of the remote device and/or preferences or interests of a user of the device. In response, the processor may select media from the media storage based on the received external factors and may then notify each remote device of the availability of the media. Use processor may also incentivize purchase of the multimedia by providing a discount or other incentive when the user of a remote device purchases one or more media items.

Example embodiments disclosed herein thereby harness characteristics of users of remote devices to select media and incentivize purchase of that media. In this manner, example embodiments disclosed herein introduce users to media likely to be of interest and, at the same time, encourage purchases of the media. As a result, example embodiments simultaneously increase enjoyment of media by users and sales of that media by media distributors, such as record companies, movie studios, and book resellers.

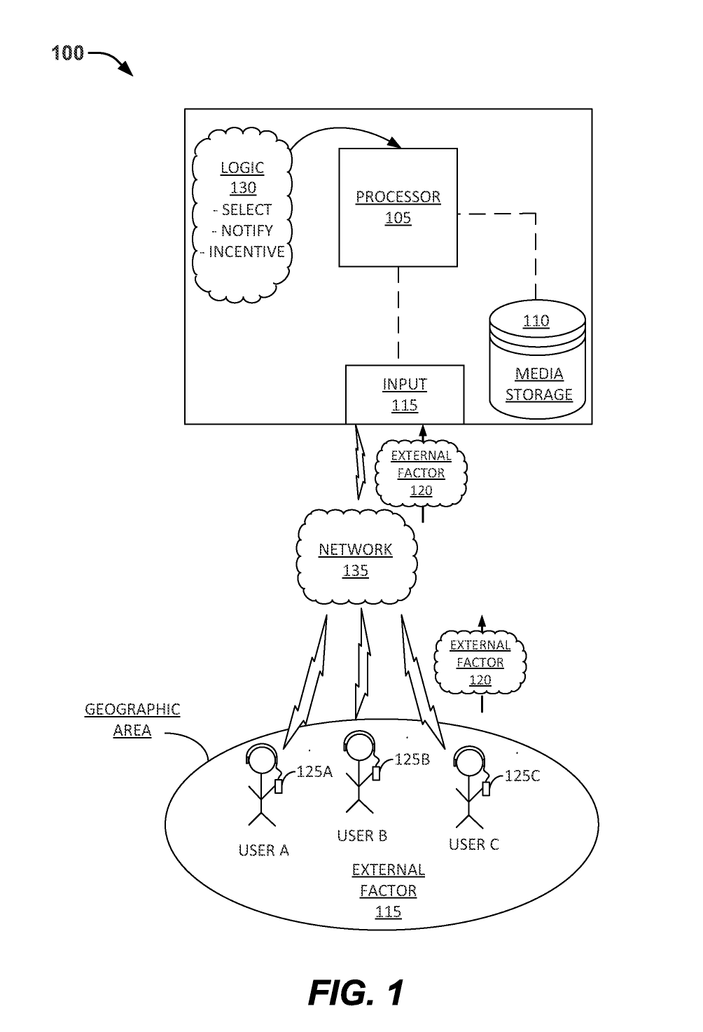

Referring now to the drawings, FIG. 1 is a schematic diagram depicting a sample incentivized media delivery device 100. The device 100 includes a processor 105 and logic 130 executable by the processor 105. The processor is directly or indirectly communicatively coupled to media storage 110 and an input 115. A plurality of media is stored or otherwise retained on or within the media storage 110. The input 115 receives an external factor 120 from a plurality of remote devises 125A, B, C.

In response at least in part to the receipt of the external factor 115, the processor 105 selects media from the media storage 110. The processor 105 can select the media from the media storage 116 based in whole or in part upon the external factor 120 communicated by the plurality of remote devices 125A, B, C to the processor 105 via input 115.

The processor 105 includes any number of computing devices, central processing units, cores or the like. The processor 105 can be located, disposed, or otherwise housed proximate the media storage 110 and the input 115, for example, within a network based media server. In other instances, the processor 105, media storage 110, input 115, and logic 130 can be located in whole or in part remotely from one another. For example, the processor 105 may be housed on a network-connected application server, while the media storage 110 may be housed on a separate network-connected storage server communicatively coupled to the application server.

The processor executes logic 130 to select media from media storage 110 and communicates the selected media to all or a portion of the remote devices 125A, B, C via the network 135. As described further below in connection with logic 130, the selection of media by the processor 108 can be based in whole or in part on the content of the external factors 120 provided to the input 115 by a plurality of remote devices 125A, B, C.

The input 115 can include any wired or wireless input communicatively coupled to the processor 105 and may receive one or more signals or data. The external factor 120 can delude any signals or data associated with or related to some or all of the plurality of remote devices 125A, B, C. Each external factor may describe a characteristic of the remote device and/or a characteristic of the user of the remote device and/or individuals associated with the user of the device (e.g., family members in the same physical location). For example, external factors 120 can include the number of remote devices within a predetermined geographic region, information describing the environment (e.g., jazz club, hip-hop dance club, restaurant, concert venue, etc.) in which some or all of the remote devices are currently located, or one or more biometric factors (e.g., age, gender, ethnicity, or health measurements, such as blood pressure, heart rate, of galvanic skin response) related to the owners or users of some or all of the remote devices. The external factor 120 can provide insight into user likes, dislikes, and preferences and such insight can assist the processor 105 in selecting appropriate media from the media storage 110.

The data described by external factor 120 may be identified in whole or in part by one or more devices housed at least partially within a remote device 125A, B, C carried by various users. The devices contributing to the external factor 125 can include, but are not limited to, global positioning system (“GPS”) sensors, near field communication (“NFC”) transceivers, Bluetooth® transceivers, or similar devices disposed within some or all of the remote devices 125A, B, C. Such systems or devices enable the external factor 120 to identify a position of the remote device within a specific geographic region or locale. For example, GPS coordinates can be used to identify a specific location (e.g. an outdoor concert venue) or a specific predetermined point related to a particular media genre a (e.g., a jazz club or a hip-hop club). As another example, cell phone tower triangulation may be used in addition or as an alternative to GPS to ascertain the physical location of the mobile device.

The external factor 120 can instead be based in whole or in part upon the network used to establish all or a portion of the communication link between the remote devices 125A, B, C and the processor 105. For example, if the remote devices 125A, B, C connect to the processor 105 via a LAN associated with a specific venue, a media genre may be deduced (e.g., connection through a symphony hall wireless LAN may enable the deduction of a “classical” media genre). Additional external data may be used to further refine the media genre. For example, continuing with the prior example, if the symphony hall schedule is available to the processor 105, it becomes possible to link the symphony hall LAN to a particular musical genre, such as a classical music on a scheduled Beethoven performance date, chamber music on a scheduled Handel performance date, and opera on a scheduled Bizet performance date. Such contextual development of media genres can provide for the delivery of highly relevant media to each of the remote electronic devices 125A, B, C.

In some instances, the external factor 120 can include one or more freely-entered or solicited manual inputs to some or all of the remote devices 125A, B, C. For example, the remote devices 125A, B, C might request user input expressing favor or disfavor of the media by, for example, allowing the user to enter a “like” or “dislike” rating for the media. The logic 130 may then further refine the selected media to choose media more lively to appeal to the users based on the received responses. Providing the user with the ability to alter the selected media through either an autonomously entered or manually-entered external factor can provide a powerful method for generating media recommendations that are current and relevant to the activities and lifestyles of the users providing the external factor 120 to the input 115.

In some instances, the number of remote electronic devices 125A, B, C can constitute all or a portion of the external factor 120. For example, using the number of devices 125A, B, C engaged in an identical or similar activity (e.g. listening to the same artist or a similar musical genre) can provide additional insight to relevant media, for example by providing data on which media, artists, etc. are popular within a particular group of users.

The plurality of remote electronic devices 125A, B, C can include any homogeneous or heterogeneous collection of electronic devices sharing the ability to deliver media to a user. The media can include, but is not limited to, audio data, video data, image data, and electronic books. The remote electronic devices 125A, B, C can include smart mobile devices, such as mobile phones, tablet computers, notebook computers, portable media players, and the like. The devices 125A, B, C may be connected via LAN, WAN, WWAN networks 135, or any other form of network connection including, but not limited to, connection via a cellular communication network. All or some of the remote electronic devices 125A, B, C can include an audio output, an image output, or any combination thereof.

The logic 130 or machine-executable instruction set executed by the processor may be stored in any memory, such as random access memory (RAM), electrically erasable programmable read only memory (EEPROM), or read only memory (ROM), or hard programmed into a processing device, such as an application specific integrated circuit (ASIC) or a field programmable gate array (FPGA). The logic can be provided either as compiled, executable code, or in uncompiled format. In at least some embodiments, the logic 130 can be provided on a non-transitory computer-readable medium, such as an optical drive, portable memory device, or the like.

The logic 130, when executed by the processor 105, permits the selection of media from the media storage 110. The selected media is chosen, based at least in part upon the external factor 120 communicated to the processor 105 via the input 115, such that the selected media is targeted to the users based on the external factor. For example, if the external factor 120 indicates that a number of remote electronic devices 125A, B, C are proximate to a known jazz club, the logic 130 may favor the selection of media by jazz artists, such as Charles Mingus, Wynton Marsalis, and the like. As another example, if the external factor 120 indicates a number of remote electronic devices 125A, B, C associated with members of a particular group are consuming video media associated with Alfred Hitchcock, the logic 130 may favor the selection of media by popular film noir artists.

The external factor 120 can change over time if, for example, the user ceases to consume one form of media (e.g. audio media) and initiates consumption of another form of media (e.g., video media). The external factor 120 can also change, for example, based upon a user's initiation of an affiliation with a user group or buddy list or open user's termination of an affiliation with a user group or buddy list. The external factor 120 can also change with proximity to a given location or to other users. For example, the external factor 120 can change based upon a user moving from a jazz club where the logic 130 would favor selection of jazz-related media to a hard rock club where the logic 130 would favor selection of rock-related media. The logic 130 therefore contextually selects media based upon a user's, actions, relationship to other users, physical relationship to known locations or venues, and the like. The logic 130 also provides selection capabilities based in whole or in part upon the user receiving providing the external factor 120, as well as other users who may share a common interest, location, or venue.

After selecting media, the logic can notify some or all of the remote electronic devices 125A, B, C of the availability of the selected media. For example, the logic 130 can transmit a notification to each remote device 125 that the media can be streamed, downloaded, or otherwise transmitted to the remote device 125. Such notifications can be tailored to the capabilities of the remote device—for example, sending a text message to devices with display capabilities, while sending audio messages to devices without display capabilities. The notification provides data related to the media selected cased upon the logic 130. For example, the notification may suggest an artist related to the location of the remote device 125 or based upon media selection of other users having an affiliation with the user of the remote device 125.

Contemporaneous with or subsequent to the notification, the logic 130 can provide incentives to the remote device based upon the user of the device completing a given task. For example, the logic 130 can provide an incentive, such as a discount offered to the user for purchasing the media selected by the logic 130 from the media storage 110. Alternatively, the logic 130 can provide a coupon useful for obtaining reduced or no cost services or products based upon the media selected by the logic 130.

In some implementations, the incentive may be selected based on the provided external factor, such that the incentive is tailored according to the plurality of remote devices 125A, B, C that provided an external factor 120. Thus, as one specific example, the discount may be scaled according to the external factors 120, such that the degree of the discount increases with the number of users. For example, logic 130 may use the external factors 120 to determine the number of remote devices within a given geographical area that are accessing the media and provide a discount in accordance with the number of devices. Thus, as one example, logic 130 may apply a tier of discounts (e.g., 10% to 5 or fewer users, 20% to 6 to 10 users, and 25% to 11 or more users). Furthermore, in some implementations, the discount may be based on the number of users who actually purchase the selected media (as opposed to the number that initially provide an external factor to logic 130). By varying the discount in this manner, the system encourages the participation and purchase of the media by multiple users.

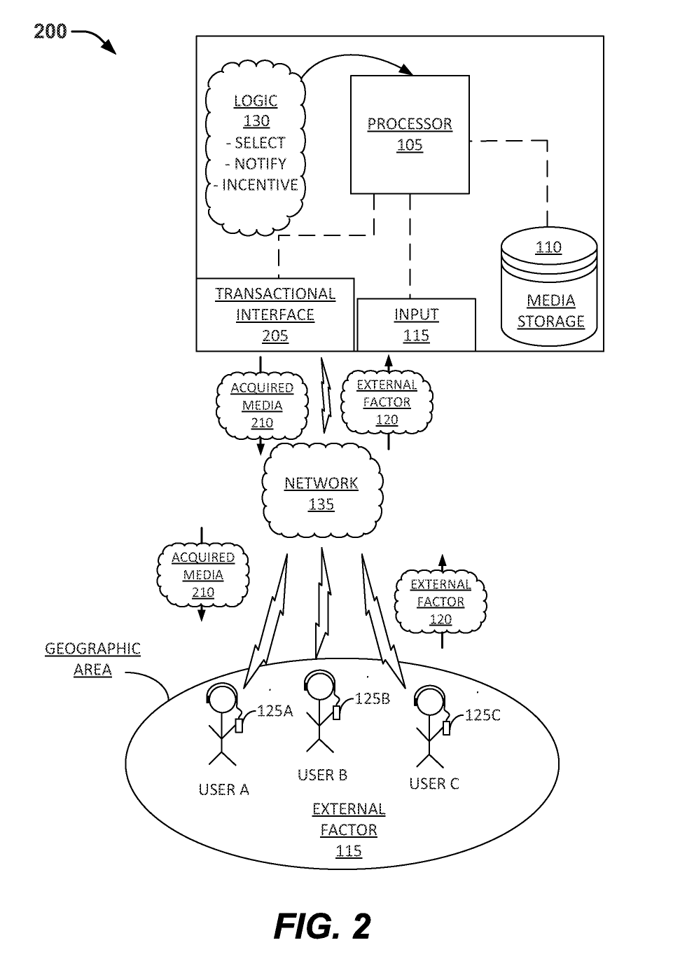

FIG. 2 is a schematic diagram depicting another sample incentivized media delivery device 200. The device 200 can include a transactional interface 205, which may be an interface to facilitate a user's purchase of access to the media selected by the logic 130. The acquisition of the selected media can be accomplished based upon a cash or credit transaction or redemption of credits from the remote device 125.

The acquired media 210 can be delivered to the remote device via any communication method. For example, the acquired media 210 can be delivered when the remote device 125 is synchronized with a network-connected device, such as a personal computer. In another example, as depicted in FIG. 2, the acquired media 210 can be delivered via the network 135 directly to the remote devices 125A, B, C via a LAN, WAN, WWAN, or other network. The delivery of the media 210 may include, for example, a download of the entire media file to the remote device 125A, B, C or streaming of the media file to the remote device 125A, B, C.

As described above in connection with FIG. 1, the combination of the processor 105, media storage 110, logic 130, and network 135 operate in conjunction to select media based at least in part on the external factors 120 transmitted to the processor 105. The logic 130 can generate a notification of the selected media that is transmitted to at least a portion of the plurality of remote devices 125A, B, C. The logic 130 can further provide incentives related to the selected media to at least a portion of the plurality of remote devices, where the incentives are selected using the external factors 120.

To give a specific example, suppose users A, B, and C each carry a remote electronic device 125A, B, C, respectively. The remote electronic devices can each provide an external factor 120, such as data related to the location of the users (e.g., that each user is located in a rhythm and blues (R&B) venue). Based on the number of users and the type of venue, the logic 130 can select additional media from the storage 110 related to the R&B genre. For example, the selected media can include popular R&B audio and R&B music videos. The logic 130 can then notify some or all of the users of the availability of the selected R&B media. Based upon the number of users in the R&B venue, the logic can then provide an incentive. For example, the incentive may be a percentage discount for purchasing the media, where the percentage discount is based on the total number of users in the location. When a given user purchases the media based on communication with transactional interface 205, the acquired media 210 may then be delivered to the user's remote device 125A, B, C via the network 135.

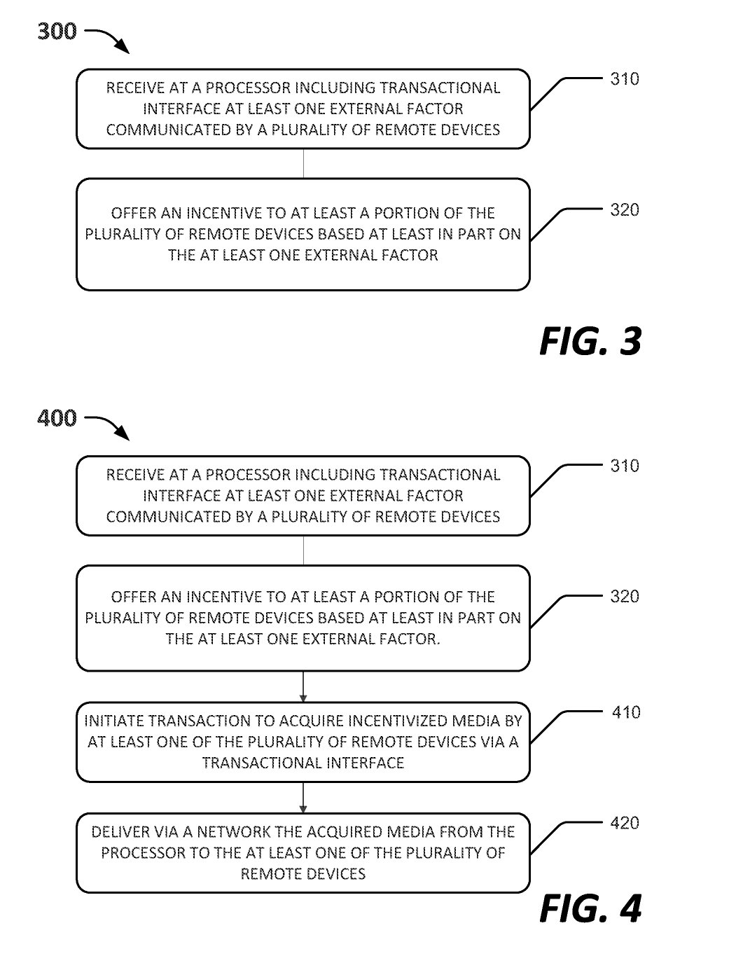

FIG. 3 is a flow diagram depleting a sample incentivized media delivery method 300. At 310, the method includes receiving at a processor 105 including a transactional interface 205 at least one external factor communicated by a plurality of remote devices 125. The external factor 120 can include any data related to the user, the remote device, the user's environment, the remote device environment, or any combination thereof. The eternal factors 120 can be received from the remote devices 125 one time, intermittently, or continuously. The external factor 120 can be adaptive based upon the number of remote devices 125, the location of the remote devices 125, a particular geographic area or venue, the environment surrounding the users or remote devices 125, or combinations thereof.

At 320 the method 300 includes offering an incentive to at least a portion of the plurality of remote devices 125 based at least in part on the at least one external factor 120. The incentive can be based in whole or in part on the external factor 120, as logic 130 may consider the number of remote devices 125, one or more geographic parameters, or combinations thereof. The incentive is delivered in a format appropriate for the remote device. For example, the notification may be audio, video, an image, a text message, or combinations thereof.

FIG. 4 is a flow diagram depicting another sample incentivized media delivery method 400. The method 400 can include a transaction initiated by at least a portion of the plurality of remote devices 125 to acquire the incentivized media selected by the logic 130.

At 410, the processor 105 can receive a transaction to acquire incentivized media by at least one of the plurality of remote devices 125 via a transactional interface 205. The transactional interface can be provided at each remote device 125 or at the processor 105. The transactional interface 205 can include an interface facilitating the acquisition of incentivized media. In some instances, the transactional interface 205 can include a monetary-based acquisition device for the incentivized media. In other instances, the transactional interface 205 can include a nonmonetary-based acquisition device, such as a system based upon credits or a similar nonmonetary means of exchange.

At 420 the acquired media 210 is delivered to the remote electronic devices 125 via the network 135. In some embodiments, the acquired media 210 is communicated from the media storage 110 to at least a portion of the plurality of remote devices 125. In some instances, the acquired media 210 is transmitted upon successful completion of a transaction via the transactional interface 205. In other instances, a protected version of the acquired media 210 can be communicated to the plurality of remote devices 125 prior to completion of the transaction, and authorized after successful completion of a transaction via the transactional interface 205.

According to the foregoing, example embodiments disclosed herein provide for a media delivery system that incentivizes purchase of highly-relevant media by users of remote devices. In particular, example embodiments select media based on external factors describing characteristics of the users and/or their remote devices, such that the media offered to the users for purchase is likely to be of interest. In addition, example embodiments provide an incentive to the users to purchase the selected media, such that sales of the media are increased. In this manner, example embodiments introduce users to media likely to be of interest, while also driving sales of the media by incentivizing its purchase.

1. A media delivery device, comprising:
a processor coupled to media storage and an input, wherein the media storage includes a plurality of media and the input is to receive m external factor from each of a plurality of remote devices; and
logic, which when executed by the processor:
selects media from the plurality of media based upon the external factor received from each remote device,
notifies the plurality of remote devices of the availability of the selected media, and
incentivizes the acquisition of selected media by the plurality of remote devices based upon the external factor received from each remote device.

2. The media delivery device of claim 1, further comprising:
a transactional interface to permit a purchase of the selected media by the plurality of remote devices.

3. The media delivery device of claim 1, wherein to incentivize the acquisition of the selected media, the processor is additionally to:
offer a discount to the plurality of remote devices, wherein the discount is selected based on a number of remote devices within a given geographical area.

4. The media delivery device of claim 3, wherein:
each external factor identifies a geographical location of the corresponding remote device, and
the processor determines the number of remote devices within the given geographical area using the external factor received from each remote device.

5. The media delivery device of claim 1, wherein each external factor comprises one or more of an identification of a particular geographic region, a description of an environmental factor associated with the particular geographic regions and a biometric factor describing a user of the remote device.

6. The media delivery device of claim 5, wherein the environmental factor associated with the particular geographic region comprises one or more of a media genre associated with the particular geographic region, an artist associated with the particular geographic region, and an event associated with the particular geographic region.

7. The media delivery device of claim 1, wherein, to select the media from the plurality of media, the logic is further to:
identify a media genre associated with a current location of the plurality of remote devices using each external factor, and
select media belonging to the identified media genre from the plurality of media.

8. A media delivery method, comprising:
receiving, at a processor including a transactional interface, an external factor communicated by each of a plurality of remote devices;
selecting media from a plurality of media based upon the external factor received from each of the plurality of remote devices; and
offering an incentive for acquiring the selected media via the transactional interface to the plurality of remote devices, wherein the incentive is determined using the external factor received from each of the plurality of remote devices.

9. The method of claim 8, wherein each external factor comprises one or more of an identification of a particular geographic region, a description of an environmental factor associated with the particular geographic region, and a biometric factor describing a user of the remote device.

10. The method of claim 8, further comprising:
receiving, from a particular device of the plurality of remote devices, a transaction to acquire the selected media via the transactional interface; and
delivering the acquired media from the processor to the particular device via a network.

11. The method of claim 8, wherein offering the incentive for acquiring the selected media comprises:
determining a number of remote devices accessing the media using each external factor; and
scaling the incentive to acquire the selected media based upon the determined number of remote devices.

12. The method of claim 11, wherein the number of remote devices is determined by using each external factor to determine a total number of devices within a given geographical area.

13. A non-transitory computer-readable medium containing an instruction set executable by a processor of a media delivery device, the instruction set comprising instructions to:
receive an external factor communicated by each of a plurality of corresponding remote devices, wherein each external factor specifies a geographical location of the corresponding remote device;
select media from a plurality of media based on each external factor; and
incentivize acquisition of the selected media by the plurality of remote devices by providing a discount based on a total number of remote devices within a given geographical area.

14. The non-transitory computer readable medium of claim 13, wherein the instructions to incentivize increase the discount as the total number of remote devices within the given geographical area increases.

15. The non-transitory computer readable medium of claim 13, the instruction set further comprising instructions to:
receive a transaction to purchase the selected media from a particular device of the plurality of remote devices; and
deliver via a network the selected media from the media delivery device to the particular device of the plurality of remote devices.
